(19) United States
(12) Patent Application Publication
(10) Pub. No.: US 2006/0274533 A1
(43) Pub. Date: Dec. 7, 2006

(54) Decorating with a lighted device

(76) Inventors: Rebecca M. Richmond, Overland Park, KS (US); Ronald L. Carlson, Riverside, MO (US); Therese F. Stieger, Liberty, MO (US); Brenda S. Klenke, Kansas City, MO (US); Keri Lauderdale Olson, Lee's Summit, MO (US); Tim R. Staley, Lenexa, KS (US)

Correspondence Address: FISH & RICHARDSON P.C., PO BOX 1022, MINNEAPOLIS, MN, 55440-1022, US

(21) Appl. No.: 11/142,836

(22) Filed: Jun. 1, 2005

(51) Int. Cl. F21V 3/00; F21V 5/00

(52) U.S. Cl. 362/311

(57) ABSTRACT

One or more decoration devices may include an internal light source that projects light through apertures formed in the outer surface of the ornament structure. Each decoration device may be equipped with a translucent divider panel that prevents viewability between a first set of apertures and an oppositely disposed, second set of apertures.

### TECHNICAL FIELD

This document relates to decorating with a lighted device, such as a holiday ornament.

### BACKGROUND

Decorations are often used as part of a celebration of an event or a season. For example, a living area or a shopping mall may be decorated with a tree having strings of lights and colored bulbs as part of the Christmas holiday season. Alternatively, a Menorah or other lighted decoration may be employed as part of a Chanukah celebration. In some circumstances, lighting effects may be used to provide a desired appearance to the decorations.

A number of factors may affect the design of such decorations, such as the lighting effects to be produced by the decoration. For example, if a decorative device is intended to appear as a Menorah, the device may include a plastic, nine-branched candelabrum with simple yellow light bulbs positioned at the top of each branch to provide the appearance of burning candles. In another example, a jack-o-lantern pumpkin decoration may include an internal candle or light bulb to produce a glowing effect during the nighttime celebration of Halloween.

### SUMMARY

A decoration device may include an internal light source that projects light through apertures formed in the outer surface of the ornament structure. The device may be equipped with a translucent divider panel that prevents viewability between a first set of apertures and an oppositely disposed, second set of apertures. In some cases, the device may be one in a group of decoration devices that are electrically connected to a circuit. Each device in the group of device may be disposed in various locations (e.g., at different parts of a Christmas tree) and may be independently illuminated or faded by a programmable controller coupled to the circuit.

In some embodiments, a decoration device may include an ornament structure having an interior space. The device may also include a first set of apertures formed in a first portion of the ornament structure and a second set of apertures formed in a second portion of the ornament structure. The first and second portions may be disposed opposite one another, and at least a portion of the interior space may be viewable through the first and second sets of apertures. The device may further include a light source disposed in the interior space such that, when the light source is activated, light projects from the light source out of the ornament structure through first and second sets of apertures. Also, the device may include a translucent divider panel disposed in the interior space between the first and second sets of apertures such that each aperture of the first set is substantially nonviewable through each aperture of the second set.

In certain embodiments, a decoration system includes a plurality of decoration devices and a circuit having a programmable controller. Each decoration device may include a light source disposed at least partially in an internal space of an ornament structure. Each ornament structure may also include a first aperture formed in the ornament structure such that light is projectable from the light source through the first aperture. Each ornament structure may further include a second aperture disposed opposite of the first aperture and formed in the ornament structure such that light is projectable from the light source through the second aperture. Also, each ornament structure may include a translucent divider panel disposed in the interior space between the first and second apertures. The programmable controller may be electrically connected to each of the light sources of the plurality of decoration devices. The programmable controller may be operable to illuminate and fade the light source of one ornament structure independently from the light source of another ornament structure.

These and other embodiments may be configured to provide one or more of the following advantages. First, the decoration device may employ an internal light source and apertures in the outer surface to provide pleasing appearance to a viewer. Second, a viewer may view light that is emitted out through the first set of apertures without the distraction of viewing completely through the ornament (e.g., by looking into the first set of apertures and out through the second set of aperture disposed on the opposite side of the ornament structure). In such circumstances, the divider panel does not permit external light or other distracting features that would ordinarily be viewable through the decoration to detract from the appearance of the light that is projected from the internal light source. Third, the decoration device may include a divider panel, an inner coating, or both to provide brighter diffused lighting. Fourth, the decoration device is capable of using a single internal light source to provide light that projects out of the front apertures and the oppositely disposed rear apertures even though a user is unable to view completely through the decoration by peering into the front apertures, through the internal space, and out of the rear apertures. Some or all of these and other advantages may be provided by the stretching systems described herein.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a decoration device in accordance with some embodiments of the invention.

FIG. 2 is a side view of the decoration device of FIG. 1.

FIG. 3 is a top view of the decoration device of FIG. 1.

FIG. 4 is a cross-sectional side view of the decoration device of FIG. 1.

FIG. 5 is a cross-sectional front view of the decoration device of FIG. 1.

FIG. 6 is a perspective view of a decoration system in accordance with some embodiments of the invention.

FIG. 7 is a front view of a control unit of the system of FIG. 6.

FIG. 8 is a side view of the control unit of FIG. 7.

FIG. 9 is a cross-sectional side view of the control unit of FIG. 8.

FIG 10 is a schematic view of a decoration system in accordance with some embodiments of the invention.

FIG. 11 is a perspective view of a decoration device in accordance with some embodiments of the invention.

FIG. 12 is a front view of the decoration device of FIG. 11.

FIG. 13 is a side view of the decoration device of FIG. 11.

FIG. 14 is a cross-sectional side view of the decoration device of FIG. 11.

Like reference symbols in the various drawings indicate like elements.

### DETAILED DESCRIPTION

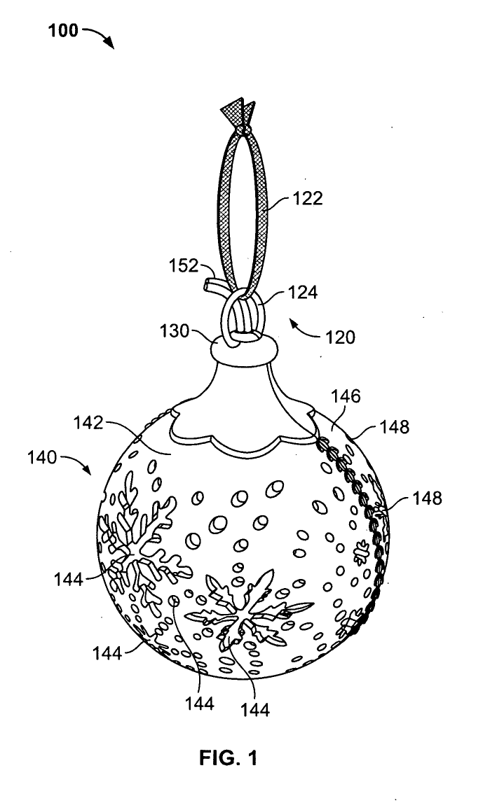

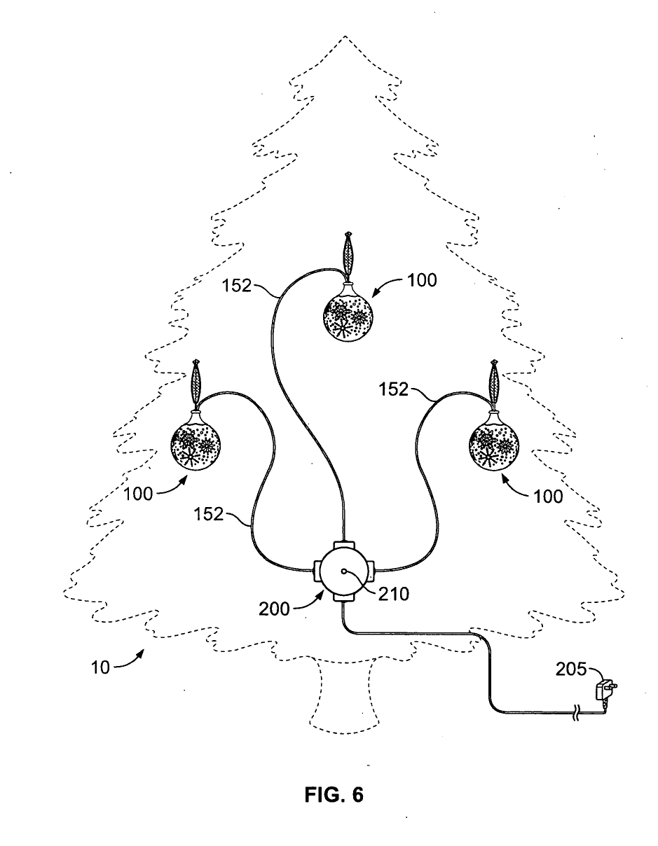

Referring to FIG. 1, a decoration 100 may include an attachment mechanism 120 and an ornament structure 140. In this embodiment, the attachment mechanism 120 comprises a ribbon 122 and a metal ring 124. The metal ring 124 is coupled to a cap member 130 of the ornament structure 140. As such, the attachment mechanism 120 may releasably couple the ornament structure 140 to an external object, such as a hook on a wall, a doorknob, a railing, or a branch of a Christmas tree (described in more detail below, for example, in connection with FIG. 6).

The ornament structure 140 may include a front surface portion 142 having one or more apertures 144 formed therethrough. Some of the apertures 144 may be formed as die cut openings that are configured to resemble patterns, characters, or words that are associated with a particular season or holiday. In this embodiment, the some of the apertures 144 on the front surface portion 142 are configured as a pattern of snowflakes and stars that can be associated with the Christmas holiday season.

Still referring to FIG. 1, the ornament structure 140 may include a rear surface portion 146 that is disposed oppositely the front surface portion 142. One or more apertures 148 may be formed in the rear surface portion 146. Because the front surface portion 142 is disposed oppositely the rear surface portion 146, the front apertures 144 may be positioned substantially opposite to the rear apertures 148. Some of rear apertures 148 may be formed as die cut openings that are configured to resemble patterns, characters, or words that are associated with a particular holiday or season. In this embodiment, the some of the rear apertures 148 are configured as a pattern of snowflakes and stars that can be associated with the Christmas holiday season.

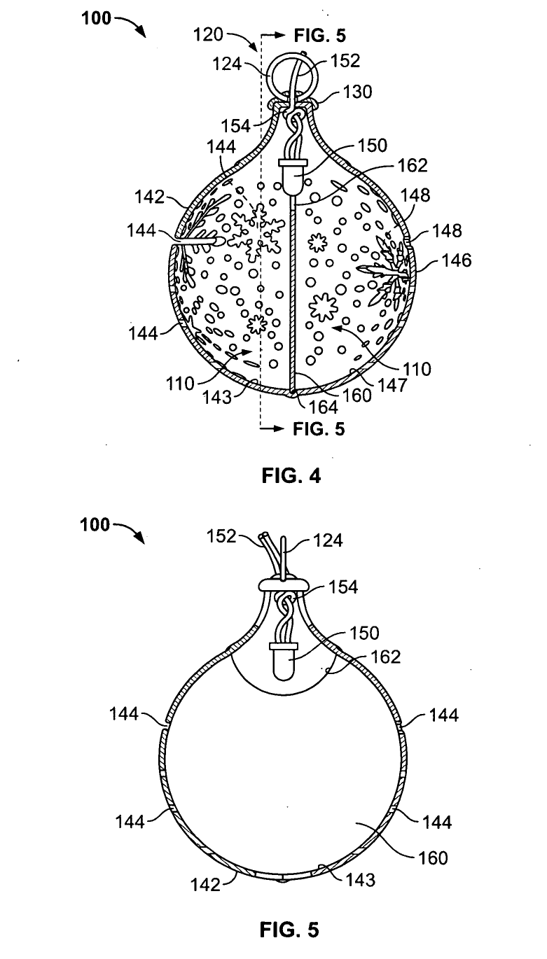

The ornament structure 140 may be substantially hollow such that an internal space is defined between the front surface portion 142 and the rear surface portion 146. An internal light source may be disposed at least partially in the internal space (as shown, for example, in FIGS. 4-5). The internal light source may emit light through the apertures 144 and 148 such that light projects out from both the front surface portion 142 and the rear surface portion 146. An electrical wire 152 may pass into the internal space to electrically connect the internal light source with an external power source. In this embodiment, the electrical wire 152 passes through the cap member 130 proximal the top portion of the decoration 100. As described in more detail below, the electrical wire 152 may join with a controller unit that is capable of selectively illuminating and fading the internal light source in the decoration 100.

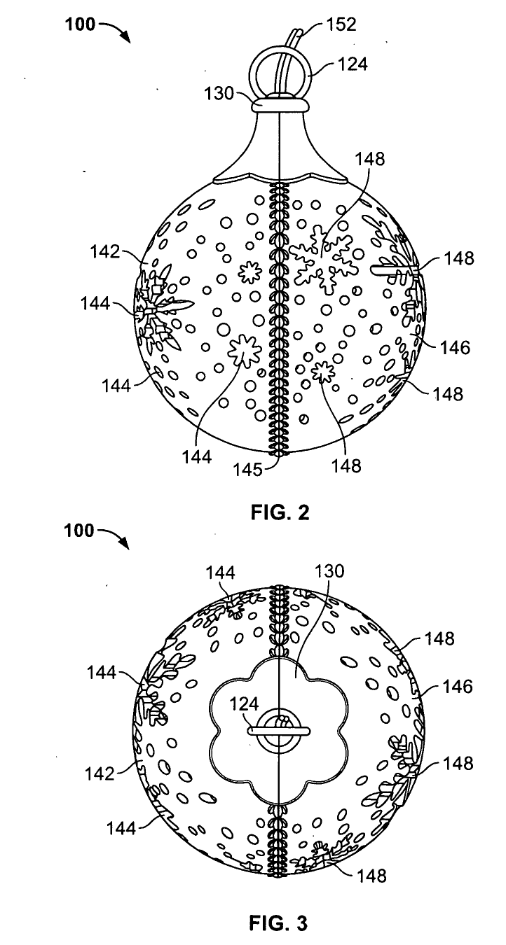

Referring now to FIGS. 2-3, the front surface portion 142 and the rear surface portion 146 may be formed as a separate shell halves that are subsequently coupled to one another. Each portion 142 or 146 may be constructed of a polymer or metallic material that can be formed to the desired shape. In this embodiment, the front and rear surface portions 142 and 146 may be formed of a substantially flame resistant polymer material, such as ABS (acrylonitrile butadiene styrene). The front surface portion 142 and the rear surface portion 146 may be coupled to one another along a border region 145. The border region 145 may include an decorative design that adds to the attractive appearance or theme of the a decoration 100. In this embodiment, the decorative design of the border region 145 is embossed into the ABS material in the area proximal to where the front surface portion 142 meets the rear surface portion 146. The cap member 130 may be affixed to the front and rear surface portions 142 and 146 after the portions 142 and 146 have been joined along the border region 145. As described in more detail below, the internal light source and a divider panel may be assembled into the internal space of the decoration 100 before the front surface portion 142, the rear surface portion 146, the cap member 130 are affixed to one another. In such circumstances, the internal light source may be used to project light out through the apertures 144 and 148 while the divider panel is capable of preventing viewability between the apertures 144 formed in the front surface portion 142 and the apertures 148 formed in the rear surface portion 146.

Referring to FIGS. 4-5, the decoration 100 may include at least one internal light source 150 that is electrically connected via the wire 152 to an external power source. In this embodiment, the internal light source 150 comprises a tri-color light-emitting diode that is capable of emitting blue light, green light, red light, or a combination thereof. As such, the internal light source 150 may project lights of various colors through the front apertures 144 and the rear apertures 148. In other embodiments, the internal light source 150 may be an ultrabright incandescent light bulb having a brightness of at least 0.25 MSCP. The internal light source 150 may be assembled into the internal space 110 by suspending the light source 150 from the wire 152 that is engaged with the cap member 130. The wire 152 may include a knot 154 that is capable of providing strain relief when the wire 152 is pulled in tension.

The internal light source 150 may be disposed proximal to the divider panel 160 that is assembled into the internal space 110 of the decoration 100. The divider panel 160 may comprise a translucent white material that is configured to permit light to transmit therethrough yet prevent viewability between the front apertures 144 on the front surface portion 142 and the rear apertures 148 on the rear surface portion 146. For example, the divider panel 160 may comprise a polypropylene or polyethylene material that is capable of permitting some light to pass therethrough and having a generally white color. The center divider panel 160 may include a channel region 162 that provides space for the internal light source 150. The channel region 162 may be disposed proximal the upper part of the front surface portion 142 and rear surface portion 146 so as to maintain the nonviewability between the front apertures 144 and the rear apertures 148 when the internal light source 150 is illuminated. In some embodiments, the channel region 162 may be configured to retain at least a portion of the internal light source 150. For example, the channel region 162 may have a shape that is complementary to the profile of the internal light source 150, in which case the walls of the channel region 162 may releasably engage the light source 150.

Still referring to FIGS. 4-5, the divider panel 160 may include an outer edge 164 that is mated with the front and rear surface portions 142 and 146 along the border region 145 (as shown, for example, in FIG. 4). A border region 145 may include a circumferential groove that is configured to receive the outer edge 164 of the divider panel 160 so that the divider panel 160 is retained in a central upright position in the internal space 110 of the decoration 100. It should be understood, however, that other embodiments of the decoration 100 may include a divider panel 160 that is assembled into the internal space 110 using a different configuration. For example, the outer edge 164 of the divider panel 160 may be adhered to the internal surface along the border region 145 so as to retain the divider panel in the upright position.

Accordingly, a single internal light source 150 may provide light that projects out of the front apertures 144 and the oppositely disposed rear apertures 148 even though a user is unable to view completely through the decoration by peering into the front apertures 144, through the internal space 110, and out of the rear apertures 148. The divider panel 160 provides brighter diffused lighting and substantially prevents an interior view of the oppositely disposed apertures 144 or 148.

Without such a divider panel 160, light that projects out of the front apertures 144 may be less brilliant or less defined due to other light or distracting features that are viewable through the oppositely disposed apertures 144 or 148. If, for example, an external green light was emitted onto the rear surface portion 146 and into the rear apertures 148, a red light that is projected out through the front apertures 144 may be substantially the same as red light from the internal light source 150 (e.g., not necessarily affected by the distracting external green light that is projected onto the rear surface portion 146). The divider panel 160 substantially prevents viewability between the front apertures 144 and the rear apertures 148 such that an external light or other distracting features that would ordinarily be viewable through the decoration 100 do not necessarily detract from the appearance of the light that is projected from the internal light source 150.

In some embodiments, the interior surfaces 143 and 147 of the front and rear surface portions 142 and 146, respectively, may be white and substantially reflective so that a substantial portion of the light from the internal light source 150 is projected out of the apertures 144 and 148. For example the internal surfaces 143 and 147 may be coated with a substantially opaque, white material that provides a sufficient amount of reflectivity. In such cases, the decoration 100 may provide an attractive appearance from the projection of one or more light colors through the apertures 144 and 148 formed in the oppositely disposed portions 142 and 146.

Referring now to FIG. 6, some embodiments of a decoration system 10 may include a group of decorations 100 (e.g., two or more) that are electrically connected to a control unit 200. The decorations 100 may be individually coupled to external portions of Christmas tree branches while the electrical wires 152 and control unit 200 remain substantially hidden from view in the inner portions of the Christmas tree. The control unit 200 may include a button 210 that is configured to activate and deactivate one or more components of a circuit (not shown in FIG. 6). Each of the decorations 100 may be electrically connected to the circuit so that, upon activation, the circuit causes the internal light sources 150 to provide certain lighting effects (described in more detail below). The control unit 200 may be coupled to a power source comprising a plug 205 that is capable of connecting to an electrical wall jack. In this embodiment, the plug is an AC/DC adaptor plug 205 that supplies direct current power to the circuit 260. As such, the control unit 200 is configured to provide power to the internal light sources 150 of the decorations 100 that are releasably coupled at various places on the Christmas tree. It should be understood that in some embodiments, the group of decorations 100 may be releasably coupled to objects other than a Christmas tree. For example the group of decorations 100 may be releasably coupled to a railing, a set of hooks, or any other structure that the attachment mechanism 120 is adapted to couple therewith.

When connected to the control unit 200, the group of decorations 100 may be configured to have synchronized lighting effects among the individual internal light sources 150. In some embodiments, the synchronized lighting effects may be arranged to appear random to the viewer (e.g., the changing light pattern from a first decoration 100 may appear random compared to the light pattern from a second decoration 100). The lighting effects may include illumination, fading, changing of light color, blinking, or other effects that may be provided by the particular light source 150. As described in more detail below, the control unit 200 may include at least one programmable controller that is capable of selectively illuminating and fading the internal light source 150 of each decoration 100 in the system 10.

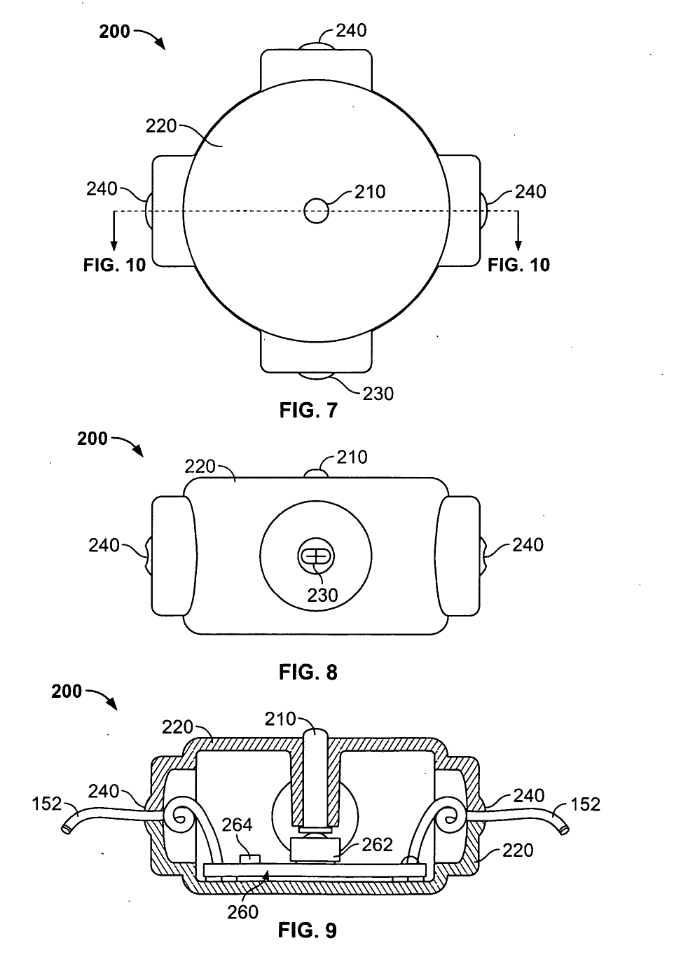

Referring now to FIGS. 7-9, the outer body 220 of the control unit 200 may comprise a thermoformed polymer material, such as ABS material. In such circumstances, the outer body 220 may thermoformed into two shell halves that are coupled to one another after the wires and circuit are assembled therein. In some embodiments, the control unit 200 may be configured to be substantially concealed in its intended site. For example, the control unit 200 may be disposed at an internal portion of a Christmas tree (e.g., among the internal braches of the tree), in which case the outer body 220 of the control unit 200 may have a dark green color so as to be substantially concealed among the green branches of the Christmas tree.

The control unit 200 may include a power device port 230 that is configured to receive a power cord attached to the plug 205 (FIG. 6). Also, the control unit 200 may include device port 240 for each of the decorations 100 that are to be electrically connected to the control unit 200. In this embodiment, the control unit 200 includes three device ports 240, each of which is capable of electrically connecting an associated decoration 100 to the circuit disposed in the control unit 200. Each device port 240 may include a wire 152 that extends from the control unit 200 and directly connects to the 10 internal light source 150 of the associated decoration 100 (as shown, for example, in FIG. 9). In other embodiments, each device port 240 may include an male or female adapter plug that is capable of mating with a complementary adapter plug at the end of the wire 152 extending from the decoration 100.

Referring to FIG. 9, the control unit 200 may house at least a portion of a circuit 260 that is capable of causing the internal light sources 150 to independently illuminate. In this embodiment, at least a portion of the circuit 260 is embodied as a printed circuit board having certain components connected thereto. The activation button 210 of the control unit 200 may engage a tactile switch 262 that is electrically connected to the circuit 260. In such circumstances, the switch 262 may sense actuation of the button 210 and signal the circuit components to activate (or deactivate). For example, the switch 262 may deactivate a programmable controller 264 until the activation button 210 is pressed, in which case the switch 262 enables the programmable controller 264 to illuminate the internal light sources 150 of the decorations 100.

In this embodiment, the programmable controller 264 is embodied as a control module that is surface mounted to the printed circuit board. The programmable controller 264 may be a single, commercially available electronic device, or the programmable controller 264 may be a more complex module comprising a plurality of electronic devices. For example, in some implementations, the programmable controller 264 could comprise a voice synthesizer device capable of storing one or more channels of data that can be output as one or more time-varying voltage waveforms. The time-varying voltage waveforms may be applied to the light sources 150 to produce corresponding time-varying changes in light intensity. For example, the programmable controller 264, with other devices in the circuit 260, may power the light sources 150 via the wires 152. In the embodiment shown in FIG. 9, the wires 152 pass through the device ports 240 and are electrically connected to the circuit board. The programmable controller 264 may be configured to independently supply voltage to each of the internal light sources 150 via the associated wire 152. As such, the group of decorations 100 may have lighting effects that, in some embodiments, appear random to the viewer (e.g., the changing light pattern from a first decoration 100 may appear random compared to the light pattern from a second decoration 100). The lighting effects may include illumination, fading, changing of light color, blinking, or the like.

In some embodiments, the switch 262 may be configured to transmit a signal to the programmable controller 264 so that the programmable controller 264 causes a new pattern of lighting effects from the decorations 100. In such embodiments, the switch may perform functions other than toggling the power to some circuit components. Instead, the activation of the switch 262 may cause the programmable controller 264 to change modes. For example, the programmable controller 264 may store several different “programs” for each channel (e.g. data that may be output as one of several time-varying voltage waveforms for each channel). Activation of the switch 262 may cause the programmable controller 264 to switch from a first mode having a first set of programs for the channels, to a second mode having a second set of programs for the channels. Accordingly, the switch 262 may effect a new pattern of lighting effects in the decorations 100.

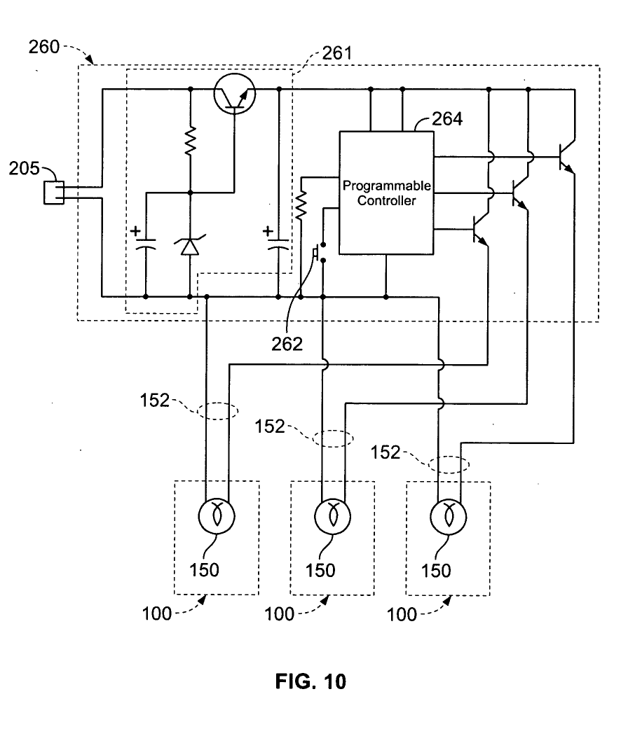

Referring to FIG. 10, the circuit 260 includes a power source 205, which provides electrical power to the programmable controller 264 and to the light sources 150. As such, the programmable controller 264 may be capable of providing synchronized lighting effects among the group of decorations 100. In this embodiments, the power source may comprise an AC/DC adapter plug 205 (see FIG. 6) that is capable of plugging into an electrical wall outlet. In other embodiments, the power sources may comprise another source of DC power, such as, for example, one or more batteries. The circuit 260 may include a set of components 261 that are adapted to provide current limiting and power conditioning functions. In some circumstances, a fuse may also be used to limit current in the circuit 260, and a voltage regulator may be used to condition the power.

The programmable controller 264 may include multiple outputs to individually control the internal light sources 150 of the decorations 100. The outputs may control a switching device that controls power to the light sources 150. For example, each output may control a transistor, as shown, and the transistor may control current to each light source 150. In some alternative embodiments, each output of the programmable controller 264 may directly power a light source 150. For example, an output may supply power through a current limiting resistor to an LED light source 150.

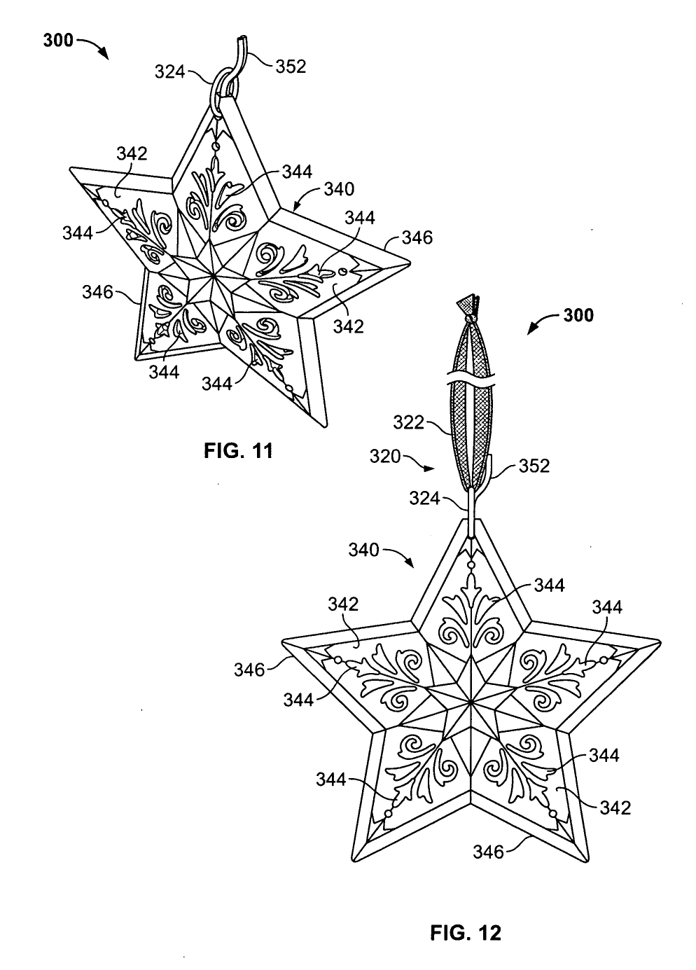

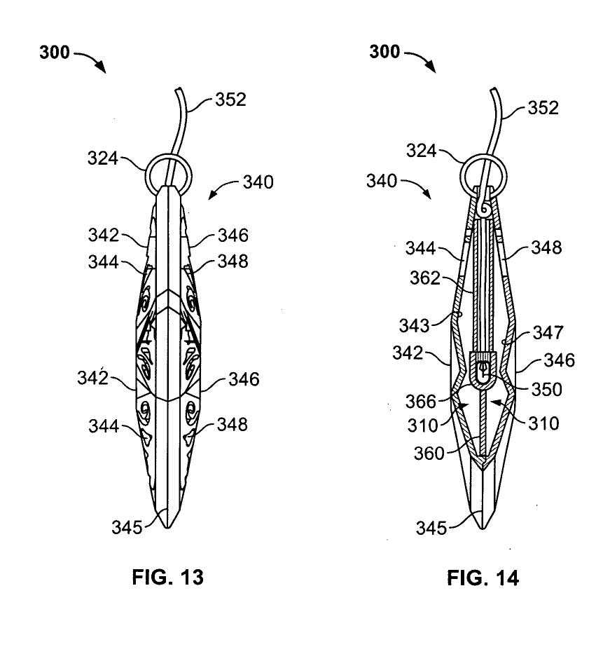

Referring now to FIGS. 11-13, some embodiments of a decoration 300 may include an ornament structure 340 having a non-spherical shape associated with a certain holiday or celebration. For example, the ornament structure 340 depicted in FIGS. 11-12 comprises a star-shaped structure that is sometimes associated with the Christmas holiday. The decoration 300 may also include an attachment mechanism 320 to releasably couple the ornament structure 340 to an external object, such as a hook on a wall, a doorknob, a railing, or a branch of a Christmas tree. In this embodiment, the attachment mechanism 320 comprises a ribbon 322 and a metal ring 324 joined with an upper part of the ornament structure 340.

Still referring to FIGS. 11-13, the ornament structure 340 may include a front surface portion 342 having one or more apertures 344 formed therethrough. Some of the apertures 344 may be formed as die cut openings that are configured to resemble patterns, characters, or words. In this embodiment, the some of the apertures 344 on the front surface portion 342 have a pattern of decorative swirls that add to the appearance of the ornament structure 340. The ornament structure 340 may also include a rear surface portion 346 that is disposed opposite from the front surface portion 342. One or more apertures 348 may be formed in the rear surface portion 346. Because the front surface portion 342 is disposed oppositely the rear surface portion 346, the front apertures 344 may be positioned substantially opposite to the rear apertures 348. Some of rear apertures 348 may be formed as die cut openings that are configured to resemble pattern, characters, or words that are associated with a particular holiday or season. In this embodiment, the some of the rear apertures 348 are configured as a pattern of swirls that substantially mirrors the pattern of apertures 344 on the front surface portion 342.

Referring to FIG. 14, the ornament structure 340 may be substantially hollow such that an internal space 310 is defined at least partially between the front surface portion 342 and the rear surface portion 346. An internal light source 350 may be disposed at least partially in the internal space. The internal light source 350 may emit light through the front and rear apertures 344 and 348 such that light projects out from both the front surface portion 342 and the rear surface portion 346. An electrical wire 352 may pass into the internal space to electrically connect with the internal light source 350. In this embodiment, the electrical wire 352 passes through an opening in the top portion of the decoration 300. As previously described, the electrical wire 352 may join with a controller unit, such as unit 200 (shown in FIGS. 6-9), that is capable of selectively illuminating and fading the internal light source 350 in the decoration 300.

Similar to some of the previously described embodiments, the front surface portion 342 and the rear surface portion 346 may be formed as a separate shell halves that are subsequently coupled to one another. In this embodiment, the front and rear surface portions 342 and 346 may be formed of a polymer material, such as ABS (acrylonitrile butadiene styrene). The front surface portion 342 and the rear surface portion 346 may be coupled to one another along a border region 345. In some embodiments, the front and rear surface portions 342 and 346 may comprises a substantially transparent ABS material while the interior surfaces 343 and 347 are coated with a white and substantially reflective material. In such embodiments, the decoration 300 may project substantially brighter light through the front and rear apertures 344 and 348 while the ornament structure 340 emits a more subtle glowing appearance or emits a substantially non-glowing appearance.

As described in more detail below, the internal light source 350 and a divider panel 360 may be assembled into the internal space 310 of the decoration 300 before the front surface portion 342 and the rear surface portion 346 are coupled to one another. In this embodiment, the internal light source 350 comprises an ultrabright incandescent light bulb having a brightness of at least 0.25 MSCP. In these embodiments, the internal light source 350 may be used to project light out through the front and rear apertures 344 and 348 while the divider panel 360 is capable of preventing viewability between the apertures 344 formed in the front surface portion 342 and the apertures 348 formed in the rear surface portion 346.

Still referring to FIG. 14, the divider panel 360 may extend to contact the inner surfaces of the border region 345. The divider panel 360 may comprise a polymer material that is configured to permit light to transmit therethrough yet prevent viewability between the front apertures 344 on the front surface portion 342 and the rear apertures 348 on the rear surface portion 346. For example, the divider panel 360 may comprise a substantially transparent ABS material that is lightly coated with a white material so that the divider panel 360 is capable of permitting some light to pass therethrough. The internal light source 350 may be disposed proximal to central area of the divider panel 360 (and proximal to the central portion of the star-shaped ornament structure 340). A tubular portion 362 may be coupled to the divider panel 360 and may extend toward the internal light source 350. The tubular portion 362 includes a lumen through which the wire 352 passes to connect with the internal light source 350. The tubular portion may be coupled with the planar portion of the divider panel 360 and may also comprise a polymer material, such as the lightly coated ABS material or a substantially white colored ABS material. In addition, a lamp cover 366 may be coupled to the divider panel 360 and may house at least a portion of the internal light source 350. The lamp cover 366 may comprise a polymer material that is capable of containing a portion of the heat generated by the internal light source 350. For example, the lamp cover may comprise a substantially transparent polycarbonate material.

Accordingly, a single internal light source 350 may provide light that projects out of the front apertures 344 and the oppositely disposed rear apertures 348 even though a user is unable to view completely through the decoration by peering into the front apertures 344, through the internal space 310, and out of the rear apertures 348. The divider panel 360 provides brighter diffused lighting and substantially prevents an interior view of the oppositely disposed apertures 344 or 348. As previously described, the divider panel 360 substantially prevents viewability between the front apertures 344 and the rear apertures 348 such that an external light or other distracting features that would ordinarily be viewable through the decoration 300 do not necessarily detract from the appearance of the light that is projected from the internal light source 350.

Similar to the embodiments described in connection with FIG. 6, a decoration system may include a group of non-spherical decorations 300 that are electrically connected to a control unit (such as unit 200). For example, the decorations 300 may be individually coupled to external portions of Christmas tree branches while the electrical wires 352 and control unit 200 remain substantially hidden from view in the inner portions of the Christmas tree. When connected to the control unit 200, a programmable controller may be configured to cause synchronized lighting effects from the individual internal light sources 350 of the decorations 300. As previously described, the synchronized lighting effects may be arranged to appear random to the viewer (e.g., the changing light pattern from a first decoration 300 may appear random compared to the light pattern from a second decoration 300). The lighting effects may include illumination, fading, changing of light color, blinking, or other effects that may be emitted from the particular light source 350.

In other embodiments, the decoration 300 may include a non-spherical ornament structure other than a star shape. For example, the ornament structure may comprise a shape of an angel, a turkey, a ghost, or an animated character.

In some alternative embodiments, the control unit 200 may receive power from a source or than an AC/DC adaptor plug. For example, the circuit may receive direct current power from a battery power supply or any other DC power source. In another example, the circuit may be configured to receive AC power from an electrical outlet plug and to sufficiently limit the voltage that is supplied to the internal light sources 150 or 350 of the decorations. In such circumstances, the internal light sources 150 or 350 may emit a light that is capable of projecting out through the front and rear apertures.

In some circumstances, the decoration may include an attachment mechanism having a different configuration other than a ribbon 124 or 324. In some embodiments, the attachment mechanism may comprise a hook, a coil, a tubular member, or a mounting bracket. For example, the decoration 100 or 300 may include an attachment mechanism in the form of a tubular member that slidably engages a branch or upper stem of a Christmas tree. In another example, the decoration 100 or 300 may include an attachment mechanism having a mounting bracket that is capable of supporting the ornament structure on a table top, a mantle, a wall, or the like.

A number of embodiments of the invention have been described. Nevertheless, it will be understood that various modifications may be made without departing from the spirit and scope of the invention. Accordingly, other embodiments are within the scope of the following claims.

What is claimed is:

1. A decoration device, comprising:
an ornament structure having an interior space;
a first set of apertures formed in a first portion of the ornament structure and a second set of apertures formed in a second portion of the ornament structure, the first and second portions being disposed opposite one another, wherein at least a portion of the interior space is viewable through the first and second sets of apertures;
a light source disposed at least partially in the interior space such that, when the light source is activated, light projects from the light source out of the ornament structure through first and second sets of apertures; and
a substantially translucent divider disposed in the interior space between the first and second sets of aperture such that each aperture of the first set is substantially nonviewable through each aperture of the second set.

2. The device of claim 1, wherein the light source is electrically coupled to a programmable controller that is operable to selectively illuminate the light source.

3. The device of claim 1, wherein at least one of the first set of apertures and at least one of the second set of apertures are configured to have shapes associated with a holiday.

4. The device of claim 1, wherein the second set of apertures are formed in a pattern that mirrors the first set of apertures.

5. The device of claim 1, wherein the light source is a single internal light source that projects light out of the first set of apertures and out of the oppositely disposed second set of apertures even though a user is unable to view completely through the ornament structure.

6. The device of claim 1, further comprising a substantially white coating on interior surfaces of the first and second portions.

7. The device of claim 1, further comprising an attachment mechanism coupled to the ornament structure.

8. The device of claim 7, wherein the attachment mechanism is operable to releasably secure the ornament structure to a portion of a Christmas tree.

9. A decoration system, comprising:
a plurality of decoration devices, each decoration device comprising:
a light source disposed at least partially in an internal space of an ornament structure,
a first aperture formed in the ornament structure such that light is projectable from the light source through the first aperture;
a second aperture disposed opposite of the first aperture and formed in the ornament structure such that light is projectable from the light source through the second aperture, and
a translucent divider panel disposed in the interior space between the first and second apertures; and
a circuit having a programmable controller that is electrically connected to each of the light sources of the plurality of decoration devices, wherein the programmable controller is operable to illuminate and fade the light source of one decoration device independently from the light source of another decoration device.

10. The system of claim 9, wherein the programmable controller is operable to cause synchronized lighting effects among the light sources of the plurality of decoration devices.

11. The system of claim 10, wherein the lighting effects comprise at least on of illumination, fading, changing of light color, blinking.

12. The system of claim 9, wherein the first and second apertures of the decoration devices are configured to have shapes associated with a holiday.

13. The system of claim 9, wherein the second aperture of each of the decoration devices is formed in a pattern that mirrors the first aperture of the associated decoration device.

14. The system of claim 9, wherein the light source of each decoration device is a single internal light source that projects light out of the first aperture and out of the oppositely disposed second aperture even though a user is unable to view completely through the ornament structure of that decoration device.

15. The system of claim 9, wherein each decoration device further comprises a substantially white coating on interior surfaces of the first and second portions.

16. The system of claim 9, wherein each decoration device further comprises an attachment mechanism coupled to the ornament structure.

17. The system of claim 16, each attachment mechanism is operable to releasably secure the associated ornament structure to a portion of a Christmas tree.
